(19) United States
(12) Patent Application Publication
(10) Pub. No.: US 2026/0102831 A1
(43) Pub. Date: Apr. 16, 2026

(54) SAW BLADE

(71) Applicant: MILWAUKEE ELECTRIC TOOL CORPORATION, Brookfield, WI (US)

(72) Inventor: Emily K. English, Wauwatosa, WI (US)

(21) Appl. No.: 19/114,855

(22) PCT Filed: Oct. 2, 2023
(86) PCT No.: PCT/US2023/034262

§ 371 Date: Mar. 25, 2025

Related U.S. Application Data
(60) Provisional application No. 63/412,042, filed on Sep. 30, 2022.

(51) Int. Cl. B23D 61/04; B23D 63/14; B23D 65/04

(52) U.S. Cl. CPC B23D 61/04; B23D 63/14; B23D 65/04

(57) ABSTRACT

A method of manufacturing a saw blade. The method includes providing a body having a plurality of cutting teeth. Each cutting tooth includes a cutting tip, a rake face extending from the cutting tip, and a relief face extending from the cutting tip opposite the rake face. The body is made of a first material. The method further includes coupling a cutting insert to the cutting tip of each cutting tooth. The cutting insert defines a longitudinal axis oriented parallel to at least a portion of the rake face. The cutting insert is made of a second material that is different than the first material. Moreover, the method includes grinding the cutting insert to a desired shape.

### CROSS-REFERENCE TO RELATED APPLICATIONS

The present application claims priority to U.S. Provisional Ser. No. 63/412,042, filed Sep. 30, 2022, the entire content of which is incorporated herein by reference.

### FIELD OF THE INVENTION

The present invention relates to saw blades and, more particularly, to circular saw blades.

### BACKGROUND OF THE INVENTION

Saw blades, such as circular saw blades, are used to remove material from a workpiece to create a cut therein. The saw blade may be operably coupled to various power tools, such as circular saws, table saws, and miter saws, to perform a cutting operation.

### SUMMARY OF THE INVENTION

The present invention provides, in one aspect, a method of manufacturing a saw blade. The method includes providing a body including a plurality of cutting teeth. Each cutting tooth includes a cutting tip, a rake face extending from the cutting tip, and a relief face extending from the cutting tip opposite the rake face. The body is made of a first material. The method further includes coupling a cutting insert to the cutting tip of each cutting tooth. The cutting insert defines a longitudinal axis oriented parallel to at least a portion of the rake face. The cutting insert is made of a second material that is different than the first material. Moreover, the method includes grinding the cutting insert to a desired shape.

The present invention provides, in another aspect, a method of manufacturing a saw blade. The method includes providing a body including a plurality of cutting teeth. Each cutting tooth includes a cutting tip, a rake face extending from the cutting tip, and a relief face extending from the cutting tip opposite the rake face. The cutting tip of each cutting tooth includes a pocket having a surface extending from the rake face. The method further includes coupling a cylindrical cutting insert to the pocket of each cutting tooth such that an end face of the cylindrical cutting insert abuts the surface of the pocket. Moreover, the method includes grinding the cylindrical cutting insert to a desired shape.

The present invention provides, in another aspect, a saw blade including a body having a plurality of cutting teeth. Each cutting tooth includes a cutting tip, a rake face extending from the cutting tip, and a relief face extending from the cutting tip opposite the rake face. The cutting tip of each cutting tooth includes a pocket having a surface extending from the rake face. The saw blade further includes a cylindrical cutting insert coupled to the pocket of each cutting tooth. The cylindrical cutting insert includes a first end face, a second end face opposite the first end face, and a curved surface extending between the first end face and the second end face. The cylindrical cutting insert defines a longitudinal axis extending between the first end face and the second end face. The cylindrical cutting insert being oriented such that the second end face faces the surface of the pocket.

### BRIEF DESCRIPTION OF DRAWINGS

FIG. 1 is a front view of a saw blade according to an embodiment of the present invention.

FIG. 2 is an enlarged view of a portion of the saw blade of FIG. 1.

FIG. 3 is an enlarged view of a cutting tooth according to another embodiment of the present invention.

FIG. 4 is an enlarged view of a cutting tooth according to another embodiment of the present invention.

FIG. 5 is a perspective view of a cylindrical carbide piece.

FIG. 6 is an enlarged view of a cutting tooth according to another embodiment of the present invention.

FIG. 7A is an enlarged view of a cutting tooth according to another embodiment of the present invention, the cutting tooth having a cutting insert illustrated in an initial state and a final state. FIG. 7B is an enlarged view of a cutting tooth according to another embodiment of the present invention, the cutting tooth having a cutting insert illustrated in an initial state and a final state.

FIG. 8 is a flowchart depicting a method of manufacturing the saw blade of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

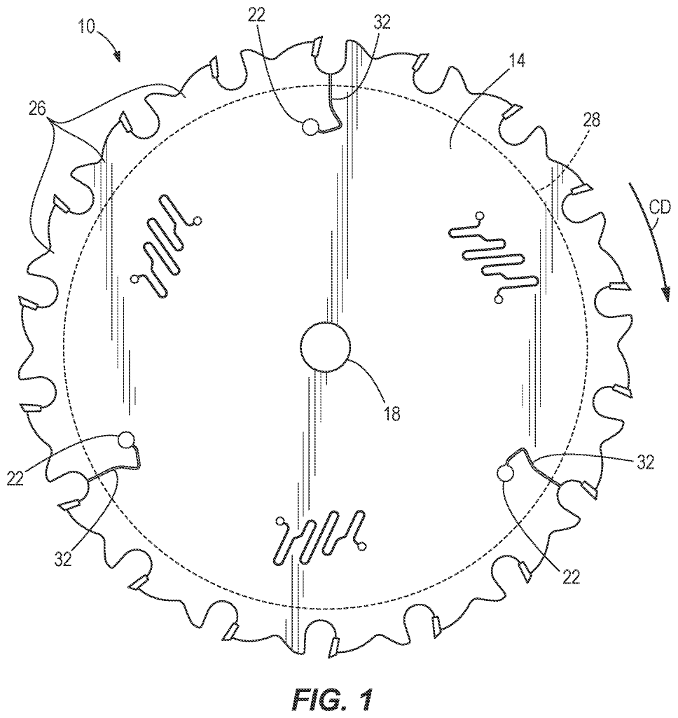

FIG. 1 illustrates a saw blade 10. The saw blade 10 is a circular saw blade that is selectively useable with a circular saw, a table saw, a miter saw, or the like. However, in other embodiments, the saw blade 10 can be different type of saw blade that can be coupled to a corresponding power tool.

As illustrated in FIG. 1, the saw blade 10 includes a body 14 and a bore 18 located in the center of the body 14. The bore 18 is configured to allow the saw blade 10 to fit on a power tool shaft that has a complementary shape to the bore 18. In the illustrated embodiment, the bore 18 has a circular shape and is configured to fit on a circular shaft. In other embodiments, the bore 18 and the power tool shaft may both be another shape, such as a diamond, square, hexagon, semi-circle, and/or the like.

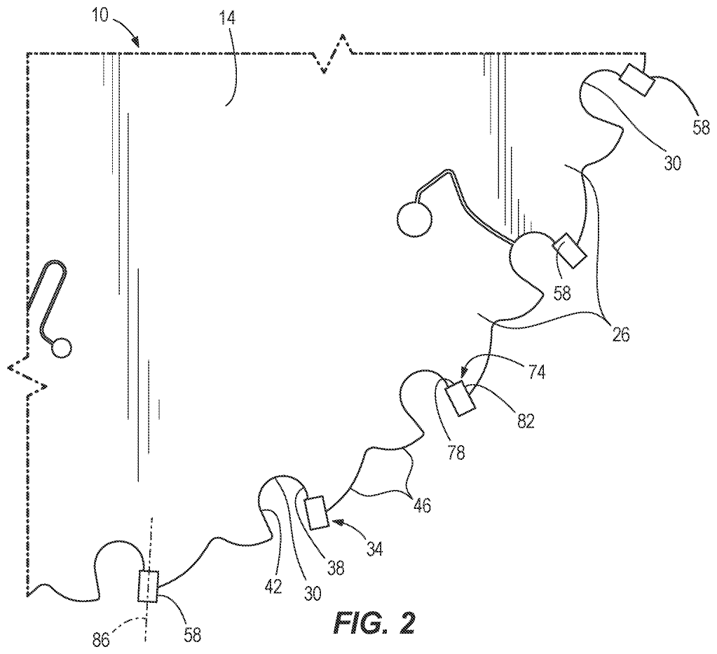

With continued reference to FIG. 1, the saw blade 10 may further include apertures or openings 22 positioned about the body 14 to provide heat dissipation, material relief, airflow, etc. In the illustrated embodiment, the openings 22 are circular, but the openings 22 could be polygonal (e.g., square, diamond, triangular, etc.), semi-circular, or the like. The saw blade 10 also includes a plurality of cutting teeth 26 that are spaced along an outer edge 28 of the body 14 and separated by a respective gullet 30 (FIG. 2) formed between adjacent cutting teeth 26. The gullet 30 is configured to allow debris (e.g., chips, chunks, etc.) passage during a cutting operation. Also, a plurality of slots 32 are defined within the body 14 of the saw blade 10 and respectively extend between one of the gullets 30 and one of the openings 22. The slots 32 enable flexing (e.g., expansion, compression, etc.) of the cutting teeth 26 under certain conditions, such as high heat cutting applications. Although the illustrated circular saw blade 10 is shown with a particular arrangement of openings 22, cutting teeth 26, gullets 30, and slots 32, this configuration is only an example. The saw blade 10 may have other configurations and arrangements of features.

The cutting teeth 26 and the body 14 may be made from a variety of materials, such as steel. In particular, the cutting teeth 26 and the body 14 can be made high carbon steel. In the illustrated embodiment, the cutting teeth 26 are integrally formed as a single piece with the body 14. In other embodiments, the body 14 may be made of bi-metal, and the cutting teeth 26 may be formed of high-speed steel that is bonded to the body 14. In still other embodiments, the saw blade 10 may be made from a variety of materials, such as when a saw blade is a masonry blade. In the illustrated embodiment, all of the cutting teeth 26 are generally the same shape and size, although relative dimensions of each cutting tooth 26 could be different in other embodiments.

With reference to FIG. 2, each cutting tooth 26 includes a cutting tip 34, a rake face 38 extending from the cutting tip 34, a heel face 42 opposite the rake face 38, and one or more relief faces 46 extending from the cutting tip 34 opposite the rake face 38. Specifically, the gullet 30 is formed between the rake face 38 of one cutting tooth 26 and the heel face 42 of an adjacent cutting tooth 26 such that the rake face 38 extends between a corresponding cutting tip 34 and the gullet 30. In the illustrated embodiment, the rake face 38 is angled forwardly in a cutting direction of the saw blade 10 (e.g., in a cutting direction CD of the saw blade 10 as shown in FIG. 1). In other embodiments, the rake face 38 may be angled rearwardly in the cutting direction of the saw blade 10.

With continued reference to FIG. 2, each cutting tooth 26 also includes a cutting insert 58 that forms at least a part of each cutting tip 34. Each cutting insert 58 can be coupled to the cutting tip 34 of each cutting tooth 26 by various welding methods (e.g., resistance welding, laser welding, cladding, etc.) and formed of various material, such as carbide. In the illustrated embodiment, the cutting inserts 58 are shown as cylindrical pieces, but may alternatively have other shapes. Once each cutting insert 58 is secured to a respective cutting tooth 26, the cutting inserts 58 can be ground to a desired shape.

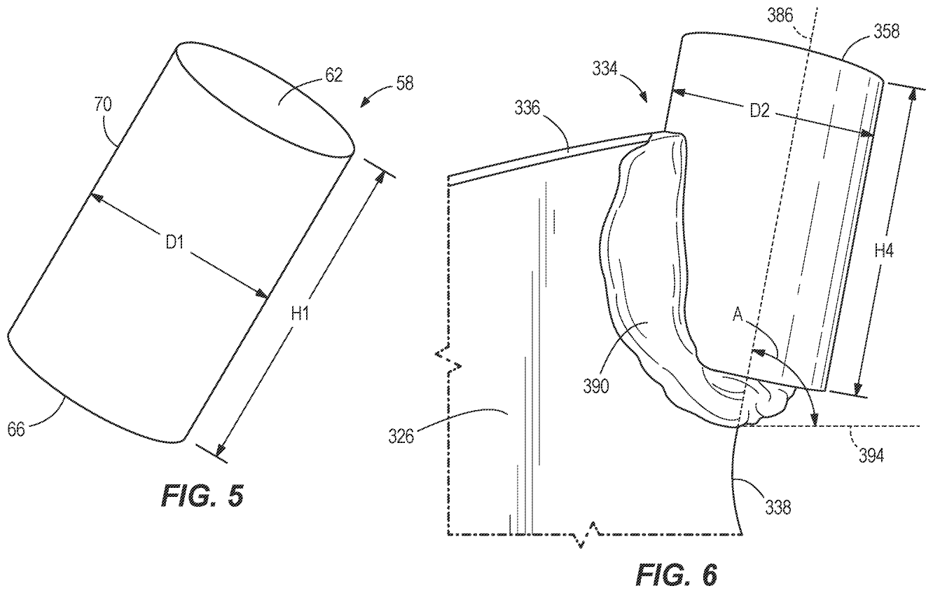

With reference to FIG. 5, each cutting insert 58 includes a first end face 62, a second end face 66 opposite the first end face 62, and a curved surface 70 extending between the first end face 62 and the second end face 66. In the illustrated embodiment, each of the end faces 62, 66 is generally planar and circular. In addition, the illustrated curved surface 70 is a continuous curved surface. Additionally, each cutting insert 58 defines a cutting insert height H1 defined between the first and second end faces 62, 66 and a cutting insert width or diameter D1 measured perpendicular to the cutting insert height H1. In some embodiments, the cutting insert diameter D1 is between 1 mm and 5 mm. The cutting insert diameter D1 preferably ranges between 2 mm and 3 mm, and is preferably about 2.5 mm.

In some embodiments, each cutting insert 58 is coupled to the cutting tip 34 by resistance welding. To couple a cutting insert 58 to the cutting tip 34 of a respective cutting tooth 26, pressure is first applied along the areas of the cutting insert 58 and the cutting tip 34 that are to be welded together. As pressure is applied, a current can then be passed through the cutting insert 58 and the cutting tip 34 to form a weld. To perform resistance welding, the material(s) used should conduct electricity. The cutting insert 58 can be formed of carbide, while the cutting tooth 26 can be formed of steel, such as high-speed steel or high carbon steel. In other embodiments, the cutting insert 58 and/or the cutting tooth 26 can be formed of other materials.

In other embodiments, the cutting insert 58 is coupled to the cutting tip 34 of a respective cutting tooth 26 by laser welding. In this process, a laser is used to create narrow and deep welds by concentrating heat along contacting surfaces of the cutting insert 58 and the cutting tip 34. Laser welding can provide a decrease in production time of the saw blade 10 in comparison to conventional welding methods. In some embodiments, the cutting insert 58 can be formed of carbide, while the cutting tooth 26 can be formed of steel, such as high speed steel or high carbon steel. In other embodiments, the cutting insert 58 and/or the cutting tooth 26 can be formed of other materials.

In further embodiments, the cutting insert 58 is coupled to the cutting tip 34 of a respective cutting tooth 26 by cladding. During the cladding procedure, a system is configured to supply a granular or powder material along the outer surface of the cutting tooth 26. An energy source, within the system, applies heat to the powder material and a target area of the cutting tooth 26. The energy source also provides a laser beam configured to be positioned on the target area of the cutting tooth 26. The heat applied by the energy source melts the powder material and the target area of the cutting tooth 26, such that the powder material and the cutting tooth 26 fuse together as the laser beam passes along the target area of the cutting tooth 26. As a result, the cutting tooth 26 and the powder material forms a bonded coating layer. The cutting tooth 26 is arranged to be movable relative to the system, so that during the cladding operation, the cutting insert 58 can be laser cladded to the cutting tooth 26 once the powder material is fused with the cutting tooth 26. In this case, the cutting insert 58 can be made of carbide or high-speed steel.

With reference back to FIG. 2, each cutting insert 58 is received within a pocket 74 formed at the cutting tip 34 of each cutting tooth 26. Specifically, the first end face 62 or the second end face 66 of each cutting insert 58 is configured to abut a base or a first surface 78 of the pocket 74, while the curved surface 70 is positioned against a wall or a second surface 82 of the pocket 74. The first surface 78 of the pocket 74 extends perpendicular from the rake face 38. The second surface 82 of the pocket 74 extends between the first surface 78 of the pocket 74 and the relief face 46 as the second surface 82 is oriented perpendicular to the first surface 78. Additionally, each cutting insert 58 is coupled to the pocket 74 such that a longitudinal axis 86 of each cutting insert 58 is oriented parallel to a corresponding rake face 38.

Welding a cutting insert 58 in such an orientation increases the strength of the weld formed between the cutting insert 58 and a corresponding cutting tooth 26. Increasing the strength of the weld inhibits the cutting insert 58 from being easily pushed off the cutting tip 34, in comparison to cutting teeth of a conventional saw blade. Moreover, increasing the strength of the weld between the cutting insert 58 and the corresponding cutting tooth 26 allows more of the cutting insert 58 to extend beyond an outer radial edge of the saw blade 10 (i.e., outermost edge of the relief face 46). As such, only a small amount of the cutting insert 58 may be grinded, so that much of the cutting insert 58 is left for cutting purposes in comparison to conventional shorter cutting teeth.

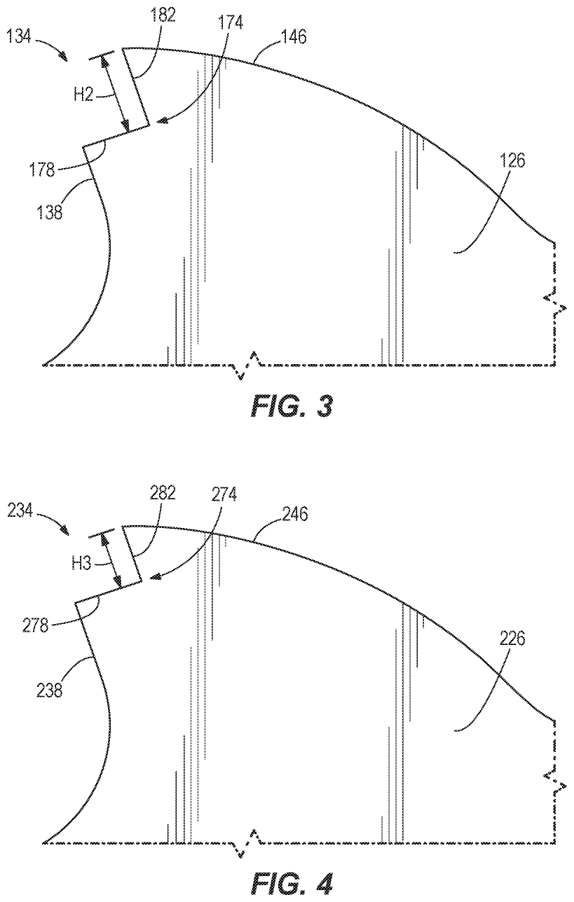

FIG. 3 illustrates another embodiment of a cutting tooth 126 that may be incorporated into the saw blade 10. The cutting tooth 126 is similar to each cutting tooth 26 of FIG. 2; therefore, like structure will be identified by a like reference number plus “100.” The cutting tooth 126 includes a cutting tip 134, a rake face 138 extending from the cutting tip 134, and a relief face 146 extending from the cutting tip 134 opposite the rake face 138. The cutting tip 134 has a pocket 174 with a first surface 178 and a second surface 182. The first surface 178 of the pocket 174 extends from the rake face 138. The second surface 182 of the pocket 174 extends between the first surface 178 and the relief face 146. A pocket height H2 of the pocket 174 is defined between the second surface 182 and an end of the relief face 146. The pocket height H2 preferably ranges between 1.5 mm and 2 mm. In the illustrated embodiment, the pocket height H2 of the cutting tooth 126 is 1.7 mm.

FIG. 4 illustrates another embodiment of a cutting tooth 226 that may be incorporated into the saw blade 10. The cutting tooth 226 is similar to each cutting tooth 26 of FIG. 2; therefore, like structure will be identified by a like reference number plus “200.” The cutting tooth 226 includes a cutting tip 234, a rake face 238 extending from the cutting tip 234, and a relief face 246 extending from the cutting tip 234 opposite the rake face 238. The cutting tip 234 has a pocket 274 with a first surface 278 and a second surface 282. The first surface 278 of the pocket 274 extends from the rake face 238. The second surface 282 of the pocket 274 extends between the first surface 278 and the relief face 246. A pocket height H3 of the pocket 274 is defined between the second surface 282 and an end of the relief face 246. The pocket height H3 preferably ranges between 1 mm and 1.5 mm. In the illustrated embodiment, the pocket height H3 of the cutting tooth 226 is 1.2 mm.

FIG. 6 illustrates another exemplary embodiment of a cutting tooth 326 that may be incorporated into the saw blade 10. The cutting tooth 326 is similar to each cutting tooth 26 of FIG. 2; therefore, like structure will be identified by a like reference number plus “300.”

The cutting tooth 326 includes a cutting tip 334, a rake face 338 extending from the cutting tip 334, and a relief face 336 extending from the cutting tip 334 opposite the rake face 338. A cutting insert 358 is coupled to a pocket of the cutting tip 334, which is covered by a weld pool 390 formed at an engagement between the cutting insert 358 and the pocket. In the illustrated embodiment, the cutting insert 358 is positioned at an oblique angle relative to the rake face 338. Specifically, the cutting insert 358 is coupled to the cutting tip 334 such that a longitudinal axis 386 of the cutting insert 358 is oriented at an inclination angle A relative to a rake face axis 394 extending perpendicular to the rake face 338. In some embodiments, the inclination angle A ranges between 55 degrees and 80 degrees. In the illustrated embodiment, the inclination angle A is about 60 degrees. In other embodiments, the inclination angle A is about 75 degrees. Additionally, the cutting insert 358 is a cylindrical carbide piece. In particular, the cutting insert 358 has a carbide grade of H10F or H6F. In the illustrated embodiment, the cutting insert 358 defines a cutting insert diameter D2 of 2.5 mm and a cutting insert height H4 of 4 mm.

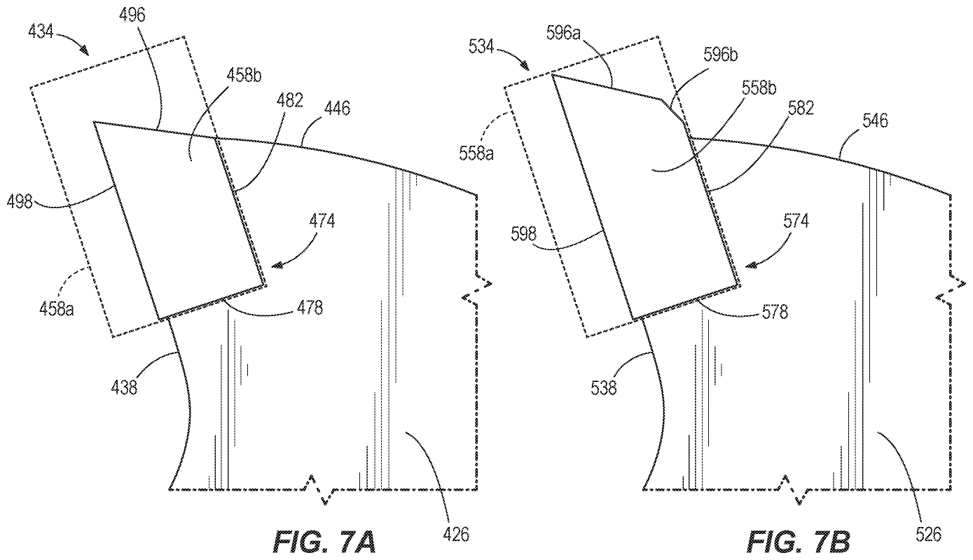

FIG. 7A illustrates another exemplary embodiment of a cutting tooth 426 that may be incorporated into the saw blade 10. The cutting tooth 426 is similar to each cutting tooth 26 of FIG. 2; therefore, like structure will be identified by a like reference number plus “400.”

The cutting tooth 426 includes a cutting tip 434, a rake face 438 extending from the cutting tip 434, and a relief face 446 extending from the cutting tip 434 opposite the rake face 438. The cutting tip 434 has a pocket 474 with a first surface 478 and a second surface 482. The first surface 478 of the pocket 474 extends from the rake face 438. The second surface 482 of the pocket 474 extends between the first surface 478 and the relief face 446.

An initial cutting insert 458a, as shown with broken lines, is coupled to the pocket 474 of the cutting tip 434 and oriented parallel to the rake face 438 of the cutting tooth 426. The initial cutting insert 458a illustrates an initial state of a cutting insert that is in the form of a cylindrical carbide piece. The initial cutting insert 458a overlaps the rake face 438 and extends beyond the relief face 446. A final cutting insert 458b, as shown with solid lines, illustrates a final state of a cutting insert that is ground to a desired shape for a cutting operation. In the illustrated embodiment, the final cutting insert 458b is ground such that a top portion 496, or relief face, of the final cutting insert 458b is substantially flush (i.e., aligns with) with the relief face 446 of the cutting tooth 426 and tapers from the cutting tip 434 to the relief face 446. The final cutting insert 458b also includes a front portion 498, or rake face, that is parallel to the rake face 438 of the cutting tooth 426. In the illustrated embodiment, the front portion 498 of the final cutting insert 458b is offset beyond the rake face 438 of the cutting tooth 426. In other embodiments, the front portion 498 of the final cutting insert 458b is substantially flush (i.e., aligns with) the rake face 438 of the cutting tooth 426. The final cutting insert 458b additionally includes side surfaces extending between the top portion 496 and the front portion 498. The side surfaces may taper toward each other from the top portion 496 such that a bottom portion of the final cutting insert 458b is narrower than the top portion 496 of the final cutting insert 458b. Alternatively, the side surfaces may be parallel to each other.

FIG. 7B illustrates another exemplary embodiment of a cutting tooth 526 that may be incorporated into the saw blade 10. The cutting tooth 526 is similar to the cutting tooth 426 of FIG. 7A; therefore, like structure will be identified by a like reference number plus “100.”

In the embodiment of FIG. 7B, the cutting tooth 526 includes a cutting tip 534, a rake face 538, and a relief face 546. The cutting tip 534 has a pocket 574 with a first surface 578 and a second surface 582. An initial cutting insert 558a, as shown with broken lines, is coupled to the pocket 574 of the cutting tip 534 and oriented parallel to the rake face 538 of the cutting tooth 526. The initial cutting insert 558a illustrates an initial state of a cutting insert that is in the form of a cylindrical carbide piece. A final cutting insert 558b, as shown with solid lines, illustrates a final state of a cutting insert that is ground to a desired shape for a cutting operation. In the illustrated embodiment, the final cutting insert 378b is ground such that a top portion of the final cutting insert 558b extends beyond the relief face 546 of the cutting tooth 526. In particular, the top portion of the final cutting insert 558b defines a first tapered portion 596a and a second tapered portion 596b. The final cutting insert 558b may also include a front portion 598 and side surfaces, similar to the final cutting insert 458b described above.

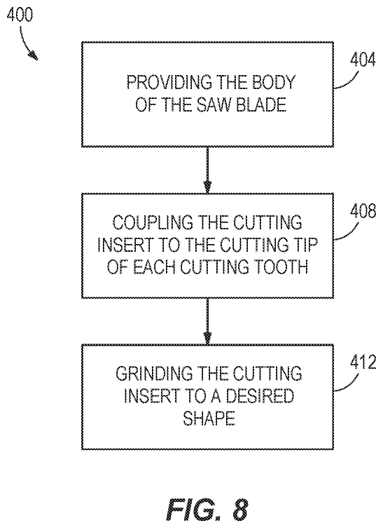

FIG. 8 depicts a method 400 for manufacturing the saw blade 10 of FIGS. 1 and 2. At step 404, the body 14 of the saw blade 10 is provided. The body 14 of the saw blade 10 is made of a first material and includes the plurality of cutting teeth 26. Each cutting tooth 26 may take the form of, for example, the cutting tooth 26, 126, 226, 326, 426, 526 of FIGS. 2-4 and 6-7B. At step 408, the cutting insert 58 is coupled to the cutting tip 34 of each cutting tooth 26. In particular, the cutting insert 58 is coupled to the pocket 74 of each cutting tip 34 such that the cutting insert 58 abuts the first surface 78 of the pocket 74. The cutting insert 58 is made of a second material that is different from the first material. As such, the first material may be steel and the second material may be carbide. The cutting insert 58 is welded to the cutting tip 34 by various welding methods such as, but not limited to, resistance welding, laser welding, and cladding.

During step 408, the cutting insert 58 is oriented on the cutting tip 34 of each cutting tooth 26 such that the longitudinal axis 86 of the cutting insert 58 is oriented relative to the rake face 38 of a corresponding cutting tooth 26. In some embodiments, the longitudinal axis 86 is oriented parallel to the rake face 38. In other embodiments, the longitudinal axis 86 is oriented at an oblique angle relative to the rake face 38. Specifically, the longitudinal axis 86 is oriented at the inclination angle A of 60 degrees or 75 degrees relative to the rake face axis 394 of the rake face 38.

At step 412, the cutting insert 58 is ground to a desired shape. In some embodiments, the cutting insert 58 is ground until the cutting insert 58 is flush with the relief face 46 of a corresponding cutting tooth 26. In other embodiments, the cutting insert 58 is minimally ground so that the cutting insert 58 extends beyond the relief face 46.

Although the invention has been described in detail with reference to certain preferred embodiments, variations and modifications exist within the scope and spirit of one or more independent aspects of the invention as described. Various features and advantages of the invention are set forth in the following claims.

What is claimed is:

1. A method of manufacturing a saw blade, the method comprising:
providing a body including a plurality of cutting teeth, each cutting tooth including a cutting tip, a rake face extending from the cutting tip, and a relief face extending from the cutting tip opposite the rake face, the body made of a first material;
coupling a cutting insert to the cutting tip of each cutting tooth, the cutting insert defining a longitudinal axis oriented parallel to at least a portion of the rake face, the cutting insert made of a second material that is different than the first material; and
grinding the cutting insert to a desired shape.

2. The method of claim 1, wherein coupling the cutting insert to the cutting tip includes welding the cutting insert to the cutting tip of each cutting tooth.

3. The method of claim 1, wherein coupling the cutting insert to the cutting tip includes coupling a cylindrical carbide piece to the cutting tip of each cutting tooth.

4. The method of claim 3, wherein the cylindrical carbide piece has a diameter of 2.5 mm.

5. The method of claim 1, wherein grinding the cutting insert includes grinding the cutting insert such that a top portion of the cutting insert is substantially flush with the relief face of a corresponding cutting tooth.

6. The method of claim 1, wherein grinding the cutting insert includes grinding the cutting insert such that a top portion of the cutting insert extends beyond the relief face of a corresponding cutting tooth.

7. The method of claim 1, wherein the first material is steel, and wherein the second material is carbide.

8. A method of manufacturing a saw blade, the method comprising:
providing a body including a plurality of cutting teeth, each cutting tooth including a cutting tip, a rake face extending from the cutting tip, and a relief face extending from the cutting tip opposite the rake face, the cutting tip of each cutting tooth including a pocket having a surface extending from the rake face;
coupling a cylindrical cutting insert to the pocket of each cutting tooth such that an end face of the cylindrical cutting insert abuts the surface of the pocket; and
grinding the cylindrical cutting insert to a desired shape.

9. The method of claim 8, wherein coupling the cylindrical cutting insert to the pocket includes orienting the cylindrical cutting insert such that a longitudinal axis of the cylindrical cutting insert is parallel to at least a portion of the rake face.

10. The method of claim 8, wherein coupling the cylindrical cutting insert to the pocket includes orienting the cylindrical cutting insert such that a longitudinal axis of the cylindrical cutting insert is at an oblique angle relative to at least a portion of the rake face.

11. The method of claim 10, wherein coupling the cylindrical cutting insert to the pocket includes orienting the cylindrical cutting insert such that the longitudinal axis is at an angle of 60 degrees relative to a rake face axis extending perpendicular to the at least portion of the rake face.

12. The method of claim 10, wherein coupling the cylindrical cutting insert to the pocket includes orienting the cylindrical cutting insert such that the longitudinal axis is at an angle of 75 degrees relative to a rake face axis extending perpendicular to the at least portion of the rake face.

13. The method of claim 8, wherein coupling the cylindrical cutting insert to the pocket includes coupling a cylindrical carbide piece to the pocket.

14. The method of claim 8, wherein coupling the cylindrical cutting insert to the pocket includes welding the cylindrical cutting insert to the pocket.

15. A saw blade comprising:
a body having a plurality of cutting teeth, each cutting tooth including a cutting tip, a rake face extending from the cutting tip, and a relief face extending from the cutting tip opposite the rake face, the cutting tip of each cutting tooth including a pocket having a surface extending from the rake face; and
a cylindrical cutting insert coupled to the pocket of each cutting tooth, the cylindrical cutting insert including a first end face, a second end face opposite the first end face, and a curved surface extending between the first end face and the second end face, the cylindrical cutting insert defining a longitudinal axis extending between the first end face and the second end face, the cylindrical cutting insert being oriented such that the second end face faces the surface of the pocket.

16. The saw blade of claim 15, wherein the longitudinal axis of at least one of the cylindrical cutting inserts is oriented parallel to at least a portion of a corresponding rake face.

17. The saw blade of claim 15, wherein the longitudinal axis of at least one of the cylindrical cutting inserts is oriented at an angle of 60 degrees relative to a rake face axis extending perpendicular to a corresponding rake face.

18. The saw blade of claim 15, wherein the longitudinal axis of at least one of the cylindrical cutting inserts is oriented at an angle of 75 degrees relative to a rake face axis extending perpendicular to a corresponding rake face.

19. The saw blade of claim 15, wherein the cylindrical cutting insert is a cylindrical carbide piece.

20. The saw blade of claim 15, wherein the saw blade is a circular saw blade.
